(19) United States
(12) Patent Application Publication
(10) Pub. No.: US 2022/0382477 A1
(43) Pub. Date: Dec. 1, 2022

(54) DATA TRANSFER ACROSS STORAGE TIERS

(71) Applicant: Citrix Systems, Inc., Fort Lauderdale, FL (US)

(72) Inventors: Daowen Wei, Jiangning (CN); Jian Ding, Jiangning (CN); Hengbo Wang, Jiangning (CN); Feng Tao, Jiangning (CN)

(21) Appl. No.: 17/330,774

(22) Filed: May 26, 2021

Related U.S. Application Data
(63) Continuation of application No. PCT/CN2021/095792, filed on May 25, 2021.

(51) Int. Cl. G06F 3/06

(52) U.S. Cl. CPC G06F 3/0647; G06F 3/0611; G06F 3/067

(57) ABSTRACT

A computing device, a method, and a computer readable medium for transferring data objects predictively to reduce consumption of resources. In some embodiments, a computing device includes: a memory; and a processor coupled to the memory. The processor is configured to store data objects in a storage system. The storage system is a multi-tier storage system. Storage of the data objects includes: determining a future demand status for at least one data object stored in the storage system based on a set of access activity rules; and moving the at least one data object between tiers of the storage system in response to the determined future demand status being different from a current demand status of the at least one data object to reduce consumption of resources in which to store that data object.

### BACKGROUND OF THE DISCLOSURE

The amount of data in cloud storage continues to grow at a significant pace. In order to manage costs in storing this growing amount of data, cloud storage providers such as Amazon Web Services (AWS, provided by Amazon of Seattle, Wash.) and Azure (provided by Microsoft of Redmond, Wash.) offer distinct access tiers. These access tiers separate pricing models for storage according to access scenarios, or needs. That is, users can store data across multiple (e.g., three, four, five, six or more) storage classes that are designed to accommodate different access requirements, with corresponding distinctions in resource consumption and associated costs.

### BRIEF DESCRIPTION OF THE DISCLOSURE

Aspects of this disclosure provide a computing device, method, and computer readable medium for storing data objects in a multi-tiered storage system.

A first aspect of the disclosure provides a computing device, comprising a memory and a processor coupled to the memory. The device is configured to store data objects in a storage system, the storage system being a multi-tier storage system, and the storage of data objects including: determining a future demand status for at least one data object stored in the storage system based on a set of access activity rules; and moving the at least one data object between tiers of the storage system in response to the determined future demand status being different from a current demand status of the at least one data object to reduce consumption of resources in which to store that data object.

A second aspect of the disclosure provides a computerized method of storing data objects in a storage system. The method includes: determining a future demand status for at least one data object stored in the storage system based on a set of access activity rules; and moving the at least one data object between tiers of the storage system in response to the determined future demand status being different from a current demand status of the at least one data object to reduce consumption of resources in which to store that data object.

A third aspect of the disclosure provides a computer readable medium having program code. The program code is executed by a computing device, and causes the computing device to store data objects in a storage system by perform actions comprising: determining a future demand status for at least one data object stored in the storage system based on a set of access activity rules; and moving the at least one data object between tiers of the storage system in response to the determined future demand status deviating from a current demand status of the at least one data object to reduce consumption of resources in which to store that data object.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative data object distribution and storage system, in accordance with an illustrative embodiment.

FIG. 2 is a data flow diagram illustrating aspects of a storage system, in accordance with an illustrative embodiment.

FIG. 3 depicts a process flow of an object storage operation, in accordance with an illustrative embodiment.

FIG. 4 is an example listing of metadata metrics gathered for a data object, in accordance with an illustrative embodiment.

FIG. 5 illustrates example records maintained for data objects, in accordance with an illustrative embodiment.

FIG. 6 illustrates time series data of access activity for a data object, in accordance with an illustrative embodiment.

FIG. 7 depicts a process flow of an object aggregation process, in accordance with an illustrative embodiment.

FIG. 8 is a graphical depiction of access intervals for a data object, in accordance with an illustrative embodiment.

FIG. 9 is a graphical depiction of access intervals for an additional data object, in accordance with an illustrative embodiment.

FIG. 10 is a graphical depiction of access intervals for an additional data object, in accordance with an illustrative embodiment.

FIG. 11 depicts a process flow of an interval determination process, in accordance with an illustrative embodiment.

FIG. 12 depicts a process flow of a data object movement process, in accordance with an illustrative embodiment.

FIG. 13 is a data flow diagram illustrating movement of data objects between storage tiers, in accordance with an illustrative embodiment.

FIG. 14 illustrates time series data of access activity for a data object, in accordance with an illustrative embodiment.

FIG. 15 illustrates time series data of access activity for a data object, in accordance with an illustrative embodiment.

FIG. 16 depicts a network infrastructure, in accordance with an illustrative embodiment.

FIG. 17 depicts a computing system, in accordance with an illustrative embodiment.

FIG. 18 is a schematic block diagram of a cloud computing environment in which various aspects of the disclosure may be implemented.

The drawings are intended to depict only typical aspects of the disclosure, and therefore should not be considered as limiting the scope of the disclosure.

### DETAILED DESCRIPTION OF THE DISCLOSURE

Certain conventional cloud storage providers require users to manually move data between tiers, e.g., to archive data in lower-priority access tiers when access is not needed and/or expenditure reduction is desirable. Other conventional cloud storage providers aim to automatically move data between tiers based on usage. These conventional “automatic” systems rely on time-based access controls that progressively move data from frequent access tiers to less frequent access tiers after a certain number of consecutive days without access. However, these conventional systems inefficiently move data between tiers, and in many cases leave data in higher access tiers for longer than necessary, adding to resource consumption.

Even further, these conventional systems have rigid, simplistic rules that only move data from less frequent access tiers to more frequent access tiers when data is accessed. These simplistic conventional systems maintain data objects previously moved to the less frequent access tiers in those less frequent access tiers (or, deeper archived access tiers) unless data is accessed. While this conventional approach can reduce resource consumption in frequent access tiers, it introduces unnecessary delays in accessing data from less frequent access tiers.

In contrast to conventional storage systems and approaches, embodiments of the disclosure include technical solutions for storing data objects in a storage system, such as a multi-tier storage system, and reducing consumption of resources in which to store such data objects. In various embodiments, the technical solutions enable moving at least one data object between tiers in response to determining a change in demand for data objects based on status (e.g., that a future demand status of the data object is different from a current demand status of the object(s)). The technical solutions include determining the future demand status of one or more data objects and moving in a fashion (e.g., proactively moving) the data object(s) that reduces consumption of resources and/or mitigates latency in retrieving the data object from a storage tier. Relative to conventional approaches, the technical solutions of the various embodiments significantly reduce latency in data object retrieval, as well as reduce consumption of storage resources (and associated costs) in storing the data object(s) by determining future demands for data objects and initiating actions to move resources to meet those future demands ahead of when those resources are needed.

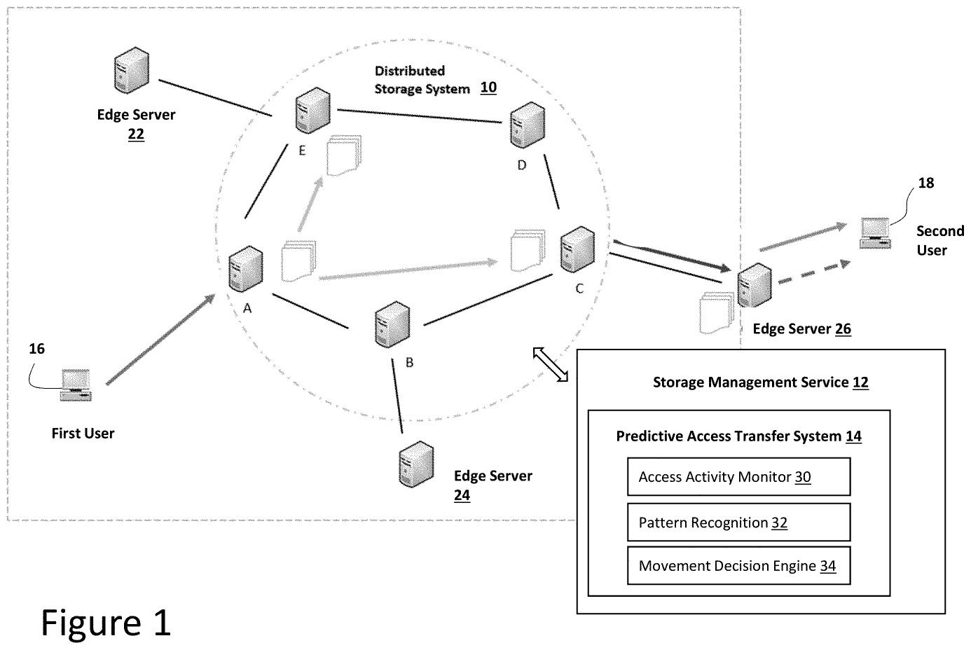

FIG. 1 depicts an illustrative content delivery network that includes a distributed storage system 10, such as a cloud, and a service (e.g., a (data) object storage management service or simply, storage management service) 12, which manages the storage of data objects in one or more portions of the distributed storage system 10. In the example shown, distributed storage system 10 includes servers A, B, C, D and E configured to store content, such as data objects (or, data files). In optional implementations, a further set of edge servers 22, 24, and 26, reside outside the distributed storage system 10 and provide potential entry points for endpoint devices, such as desktops, laptops, smartphones, smart devices, etc. Edge servers 22, 24, and 26 are often deployed to, for example, reduce the workload on the storage system 10 servers and reduce latency for end users.

In various implementations, a first user 16 at a first endpoint device uploads a data object (or, file) directly to the distributed storage system 10, which then stores copies of the data object in one or more servers, e.g., by replicating the data object (or parts of the data object with erasure coding) to a subset of the servers A, C and E. As used herein, a “data object” can include one or more data files, folders, etc. In various implementations, data objects include metadata about the data files, folders, etc., that are stored in the data object. In certain cases, data objects include files such as documents, image files, video files, compressed files and/or folders, groups of files, files stored in one or more locations (including duplication in one or more locations), etc. This listing of data objects is strictly illustrative, and is not exhaustive. In some cases, the data object is intended to be shared with a second user 18 using a second endpoint device. In other cases, the data object is intended to be accessed by the first user 16 and/or the second user 18 at a later time. In some particular embodiments, the data object is likely to be accessed frequently, e.g., on a daily, or weekly basis. In other particular embodiments, the data object is likely to be accessed infrequently, e.g., less than once per month or once per year. In certain scenarios, the data object can be stored (e.g., cached) on edge servers (e.g., edge server 26) for access by one or more users (e.g., second user 18). However, caching and local storage at edge servers is not always practical for large quantities of data objects, and as such, at least some of these data objects are stored in one or more servers A-E in the storage system 10. These servers A-E manage data storage in tiers, e.g., two, three, four or more tiers that provide a tradeoff between storage resource consumption (e.g., processing and memory requirements) and latency in retrieval.

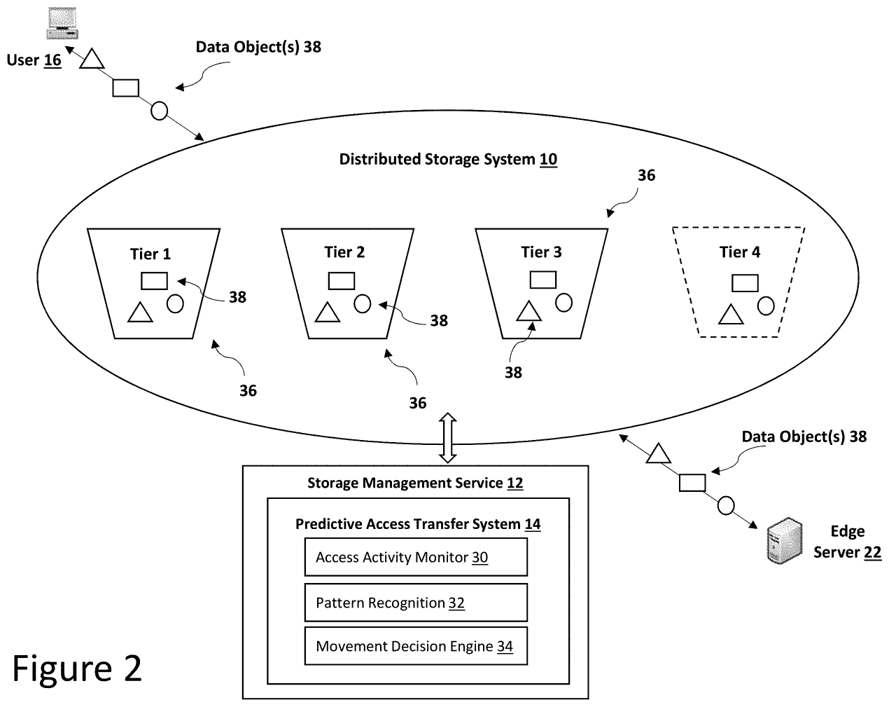

As noted herein, the storage management service 12 is configured to manage storage of data objects in the distributed storage system 10 (and in some cases, in edge servers(s) 22, 24, 26) with a predictive access transfer system 14. In various embodiments, the predictive access transfer system 14 applies a set of access activity rules to decide whether and when to move data objects 38 (shown in FIG. 2) between tiers in the storage system 10. The predictive access transfer system 14 can include an access activity monitor 30 that tracks access activity from the distributed storage system 10 (and/or edge servers 22, 24, 26) for one or more data objects. A pattern recognition module 32 is configured to recognize patterns in the access activity from access activity monitor 30 in order to determine a status (e.g., a future demand status) for the data object(s). The movement decision engine 34 is configured to make decisions to move one or more data objects based on determinations of the pattern recognition module 32, e.g., in response to the determined future demand status differing from a current demand status. As such, the predictive access transfer system 14 is configured to reduce consumption of resources in which to store the data object(s). When compared with conventional approaches, system 14 is configured to move data objects to storage tiers that more accurately correspond with a future demand status. For example, the system 14 can be configured to identify data objects that are unlikely to be accessed in the short-term, and proactively move those data objects to archive and/or deep archive storage tiers with lower resource consumption (e.g., equipment, processing and memory requirements) and increased latency in retrieval. In various additional implementations, the system 14 reduces latency in accessing data objects in the storage system 10 (or elsewhere). For example, the system 14 can be configured to identify data objects that are likely to be accessed in the short-term, and retain those data objects in first or second tier storage associated with greater resource consumption (e.g., equipment, processing and memory requirements), with a corresponding decrease in access latency.

While embodiments are described herein with reference to servers and a distributed storage system, it is understood that the concepts may be applied to any type of device network that utilizes multi-tiered storage (e.g., one or more storage tiers, which can utilize edge devices) to facilitate content sharing. Further, it is understood that the predictive access transfer system 14 may be implemented by one or more computing devices within the distributed storage system 10, by one or more computing devices outside of the distributed storage system 10, or by a combination of the two. It is also understood that predictive access transfer system 14 may be implemented within the storage management service 12, or be implemented separately from the storage management service 12.

FIG. 2 depicts an example of storage tiers 36 in the distributed storage system 10, which are configured to store data objects 38 as managed by the storage management service 12 (including predictive access transfer system 14). Generally, storage tiers 36 enable storage of data objects 38 (e.g., for current or later access) according to usage. For example, data objects 38 accessed more frequently can be stored in higher-priority tier(s) 36, while data objects 38 accessed less frequently may be stored in lower-priority tier(s) 36. Higher-priority tiers (e.g., Tier 1) are sometimes referred to as “hot” storage, while lower-priority tiers (e.g., Tier 3, Tier 4) are sometimes referred to as “cold” storage. In practice, higher-priority tiers can deploy relatively advanced drives, faster transport protocols, and may be located near the client and/or in multiple locations. These higher-priority tiers can be tailored to have relatively low latency and higher transactional rates than lower-priority tiers. Lower-priority, or cold storage tiers can deploy relatively basic or less sophisticated drives, standard or slower transport protocols, and may store data offline or in locations that are farther from the client. Storage tiers that function in a hybrid role between hot and cold storage can also be utilized. Storage providers can use different terms to refer to distinct storage tiers and hierarchies. For example, certain storage providers delineate storage into two tiers: standard and archive. Others delineate storage into several tiers or more, e.g.: primary, archive, and additional (deep) archive(s); or frequent, infrequent, archive, deep archive. Regardless of nomenclature, distinct storage tiers described herein can exhibit relative differences in resource consumption, storage capacity and/or retrieval latency, among other characteristics.

With continuing reference to FIG. 2, arrows are shown as examples indicating the ability of user 16 (and/or other users) and edge server 22 (and/or other connected edge servers) to store and access data objects 38 in the distributed storage system 10. Upon entering the distributed storage system (or simply, storage) 10, the data objects 38 are placed in a storage tier 36, e.g., Tier 1, Tier 2, Tier 3, etc. In this example depiction, storage 10 includes at least three tiers 36. However, an additional tier (Tier 4) is illustrated in phantom as optional. Further storage tiers 36 are also possible in keeping with the various embodiments. In certain embodiments: Tier 1 is intended for accessing one or more data objects 38 on a frequent basis (e.g., every day, every several days, once a week, etc.); Tier 2 is intended for accessing one or more data objects 38 on basis less frequent than Tier 1 (e.g., bi-weekly, monthly, etc.); and Tier 3 is intended for archiving data objects 38 accessible on a basis less than Tier 1 and Tier 2 (e.g., quarterly, annually, etc.). In the example including Tier 4, that tier is intended for deep archiving of data objects 38, which may be accessed less frequently than Tiers 1-3, for example, once a year or once every few years. Each Tier has an associated latency for retrieval (or, access) to objects stored in that Tier. That is, the time between an access request from a client and actual access to the data object 38 by the client can vary based on the Tier in which the object is stored 38. In one example: Tier 1 has a first access latency, Tier 2 has a second access latency, and Tier 3 has a third access latency, where the first access latency is less than the second access latency, and the second access latency is less than the third access latency. In the example including Tier 4, that tier has a fourth access latency that is greater than the third access latency.

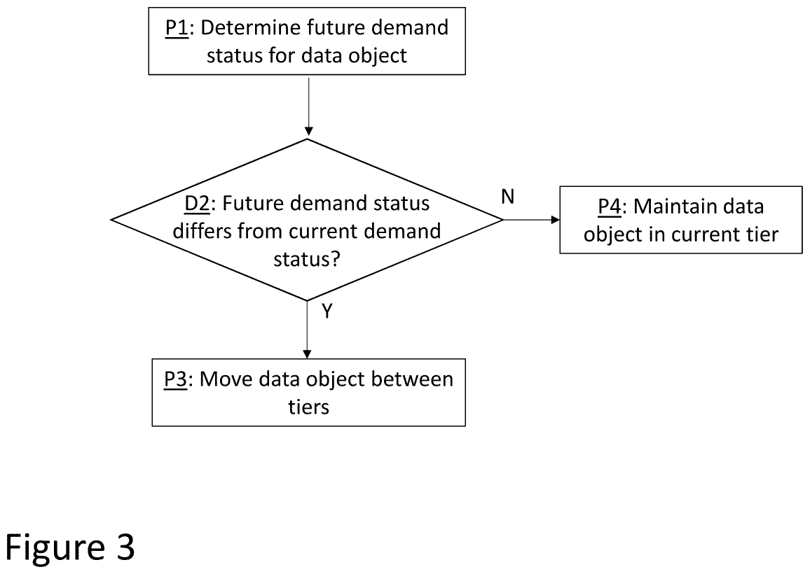

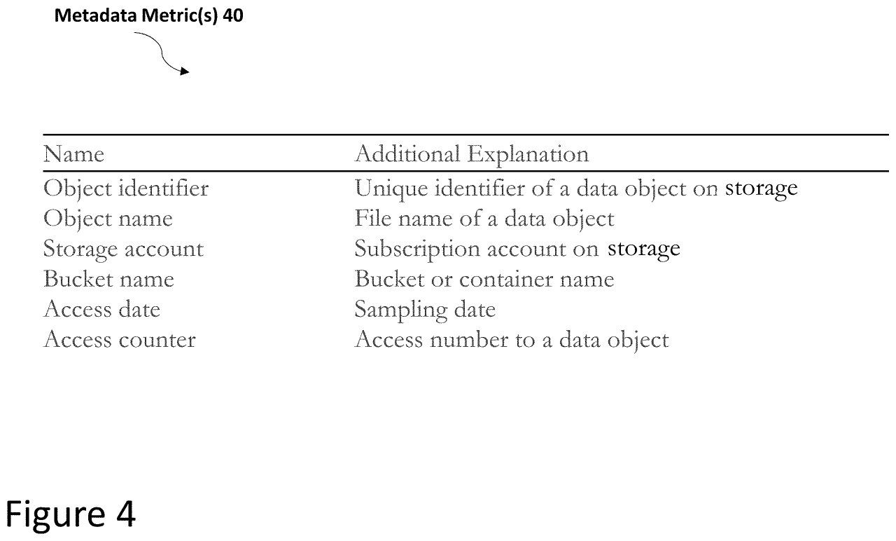

FIG. 3 is a flow diagram illustrating processes in a method performed by the service 12 (e.g., a storage management service including predictive access transfer system 14) according to embodiments. As shown, in a first process P1, the predictive access transfer system 14 is configured to determine a status (e.g., a future demand status) for at least one data object 38 stored in the storage system 10 based on a set of access activity rules. As described herein, the future demand status can be based on access metrics that are recorded for the data object 38 over a period, and in certain cases, are updated within that period (e.g., for multiple access instances). In decision D2, the predictive access transfer system 14 compares the status (e.g., future demand tier 36) with another status (e.g., a current demand tier 36) to determine whether the statuses differ from one another. If so (Yes to D2), in process P3, the predictive access transfer system 14 moves the data object 38 between tiers 36 (e.g., to the tier associated with the future demand status) to reduce consumption of resources in which to store that data object 38. If No to D2, in process P4, the predictive access transfer system 14 maintains the data object 38 in its current tier (e.g., updating records accordingly, or taking no action). Further details of the processes illustrated in FIG. 3 are shown in FIGS. 4-15. As noted herein, in various implementations, the processes illustrated in FIG. 3 (as well as sub-processes) can be performed during a period when computing resources (e.g. processing) are in lower demand, e.g., later in the evenings and/or early in the mornings. In some cases, these processes are initiated daily, at or around midnight.

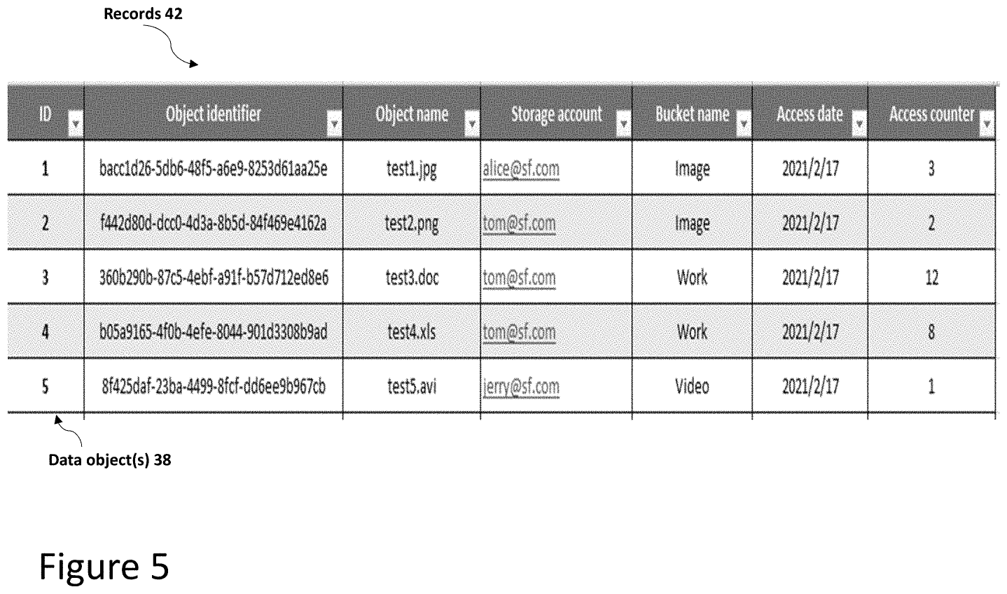

FIG. 4 shows an example of metrics (e.g., metadata metrics 40) about access to data objects 38 as captured by the access activity monitor 30 (e.g., at the backend of storage 10). It is understood that these metadata metrics are a non-exhaustive, merely illustrative example of some of the metadata metrics that the access activity monitor 30 can track about access to data objects 38, e.g., by user(s) 16, edge server(s) 22, etc. The metadata metrics 40 are accessed (and maintained) by the access activity monitor 30 in records, as illustrated in one example of several records 42 shown in FIG. 5. With reference to FIGS. 2-5, the records 42 include metrics such as an object identifier, object name, storage account (e.g., associated with a user, edge server, enterprise system, etc.), a bucket or container name, an access date, and an access counter. In certain embodiments, access activity monitor 30 creates a new record 42 to track the first access activity of a data object 38 in a given period, e.g., in a sequential period such as on consecutive days. In particular cases, access activity monitor 30 creates a new record 42 to track the first access activity of a data object 38 in a period (e.g., in a day). In these cases, for a given record 42, the access activity monitor 30 can update the access counter (FIG. 5) for individual access activities for the data object 38 within the period. For example, referring to data object ID1 in FIG. 5, the access activity monitor 30 creates a new record 42 for the first access instance of that data object (ID1) in a period (e.g., in a day), and updates the access counter for that data object each time the data object (ID1) is accessed within that period (e.g., in the same day). In this example, IDI is created as a record 42 on 2021 Feb. 17 in response to the first access instance for that data object on that date. Because ID1 was accessed two additional times on 2021 Feb. 17, the access counter at the end of that one day period is listed as “3.”

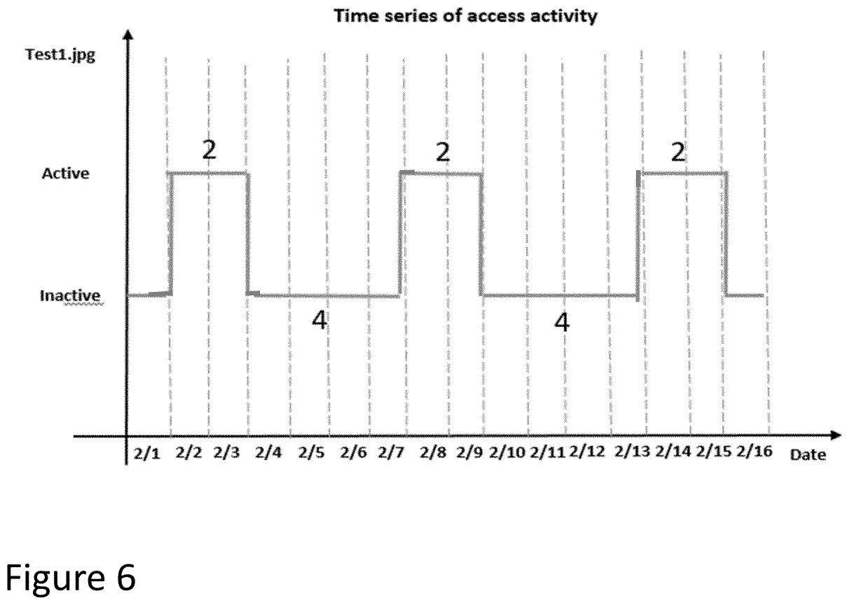

The access activity monitor 30 is also configured to identify or otherwise tag data objects 38 on a periodic basis, without the need for activity relating to that data object 38. In some examples, access activity monitor 30 tags all data objects 38 in the distributed storage system 10 on a periodic basis (e.g., daily, weekly, bi-weekly, etc.) with an activity status. In particular examples, the activity status is either active or inactive. With continuing reference to FIG. 5, the access activity monitor 30 is configured to identify data objects 38 in a period (e.g., daily) with an active status when the access counter for that object 38 within the period (e.g., day) is greater than zero. In these cases, the access activity monitor 30 identifies data objects 38 in a period (e.g., daily) with an inactive status when the access counter for that object 38 is equal to zero. FIG. 6 is a graphical depiction of the time series of access activity for an example data object 38, as provided in records 42. In this example, the width of the square wave is equal to the number of consecutive days with the same activity status for the object 38, e.g., active v. inactive.

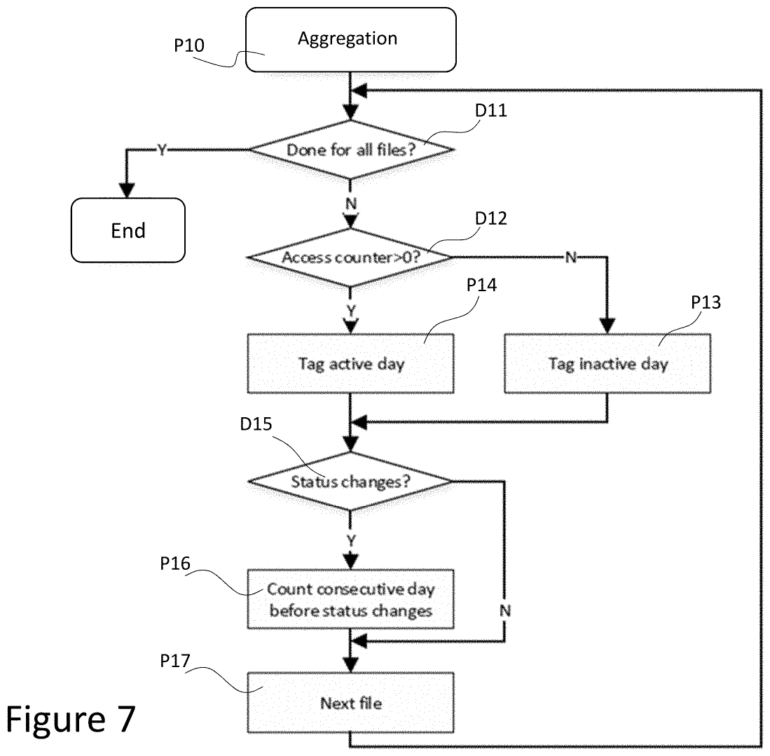

FIG. 7 is a flow diagram illustrating processes in a method of recording access metrics for data objects 38 (FIG. 2) in a given period according to embodiments. As noted herein, in some cases, the given period is a daily period such as an approximately 24 hour period. Processes in FIG. 7 can be performed by any aspect of predictive access transfer system 14, but in particular cases, are performed by access activity monitor 30. As shown, in a first process P10, recording (or, aggregation) is initiated for a set of objects 38 in the given period, e.g., every day. In decision D11, access activity monitor 30 determines whether access metrics for all data objects 38 have been aggregated within the period. If Yes to D11, the process ends. If No to D11, in decision D12, the access activity monitor 30 determines whether the access counter is greater than zero, i.e., that the object 38 has been accessed within that period, such as within that day. If the access counter is zero (No to D12), the period (e.g., day) is tagged as inactive in process P13. If the access counter is greater than zero, in process P14, the period (e.g., day) is tagged as active. The access activity monitor 30 then determines, in decision D15, whether the active or inactive tag is a status change as compared with the prior period (e.g., previous day). If Yes to D15, in process P16, access activity monitor 30 records the consecutive periods (e.g., days) before the detected status change. Following process P16, access activity monitor 30 selects a next data object 38 (in process P17) in the storage system 10 and reverts back to decision D11 with that next data object 38. If No to D15 (i.e., no status change from prior period), the process proceeds directly to P17 to select the next data object 38 and revert back to D11 with that next data object 38.

With activity status information monitored and recorded, the pattern recognition (module) 32 is configured to recognize patterns in activity status for a given object 38 or groups of objects 38 with similar activity status or other characteristics. In certain cases, pattern recognition 32 identifies one of at least four access patterns: a) a double cyclic-like pattern where the consecutive active days and the consecutive inactive days occur cyclically over time; b) an active cyclic-like pattern where the consecutive active days occur cyclically over time, while the consecutive inactive days distribute randomly; c) an inactive cyclic-like pattern where the inactive days occur cyclically over time while the active days do not; and d) a stochastic pattern where both active and inactive consecutive days distribute randomly. In various implementations, the pattern recognition module 32 is configured to treat objects 38 with a same or similar access pattern type in a similar manner. That is, in particular cases, objects 38 with same or similar access pattern types can be grouped and moved between storage tiers collectively or individually. In some examples, groups of objects 38 with same or similar access patterns can be moved between storage tiers simultaneously, sequentially, or at distinct (delayed) intervals.

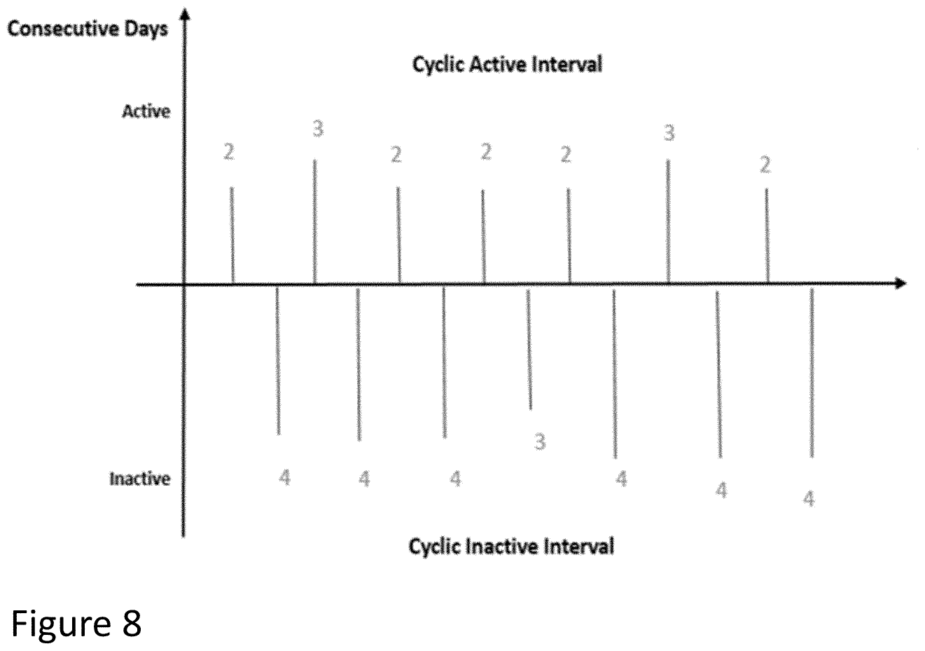

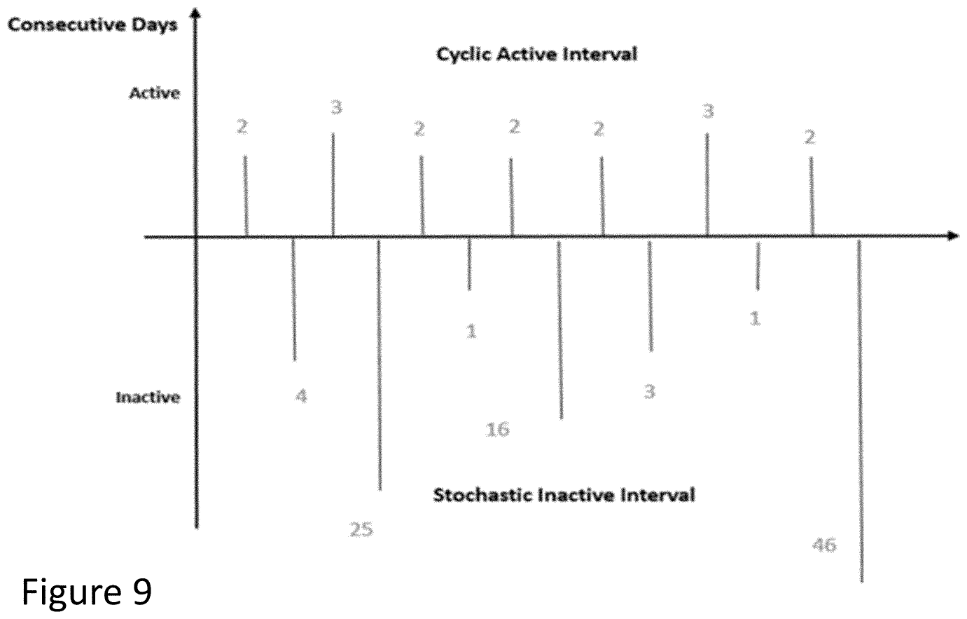

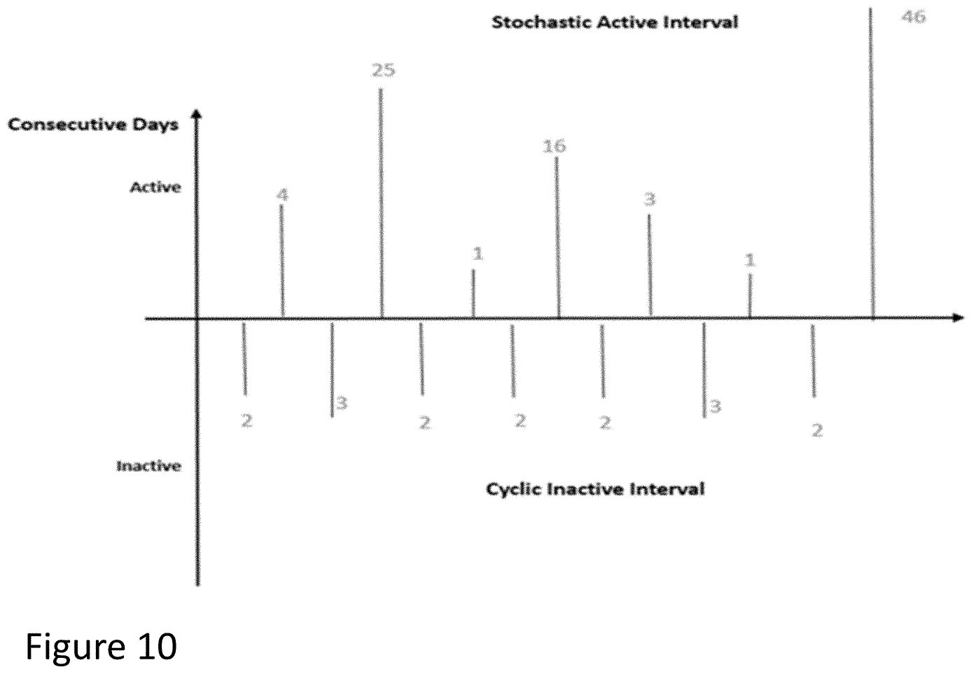

FIG. 8 is an example graph illustrating active and inactive intervals for a given data object 38. This depiction illustrates a cyclic-like pattern, e.g., a double cyclic-like pattern, where active and inactive consecutive days switch back and forth over time. As shown, consecutive inactive days are interspersed between active days, e.g., with two consecutive active days followed by four consecutive inactive days, which are in turn followed by three consecutive active days, etc. As noted herein, active days indicate active status for a data object on a given day. In various implementations, the pattern recognition module 32 is configured to detect one or more patterns in the access status activity, and in the example of FIG. 8: a cyclic active time series [2, 3, 2, 2, . . . ] and a cyclic inactive time series [4, 4, 4, 3, . . . ]. FIGS. 9 and 10 illustrate additional examples of active status patterns for a given data object 38, in these cases, imbalanced cyclic-like patterns. The pattern in FIG. 9 is characterized by approximately cyclical active intervals with stochastic inactive intervals, while the pattern in FIG. 10 is characterized by approximately cyclical inactive intervals with stochastic active intervals.

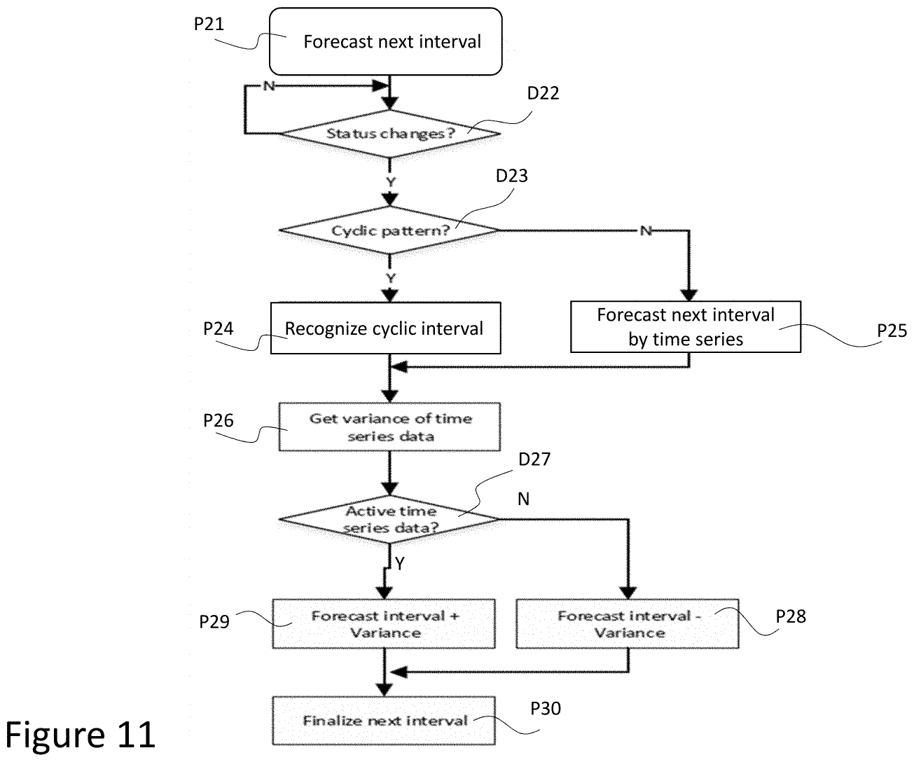

FIG. 11 illustrates processes performed by the predictive access transfer system 14 (e.g., pattern recognition module 32) to determine (or, forecast) whether a next interval (e.g., day) will be active or inactive. In these implementations, in process P21, the system 14 initiates determining whether a next interval will be active or inactive. In particular implementations, determining the active or inactive status of a next interval is performed concurrently with, or following the periodic aggregation process described with reference to FIG. 7. In additional implementations, determining the active or inactive status of a next interval is performed on a periodic basis within an aggregation period (e.g., once, twice, etc. within a given period; or once in every other period, every two periods, etc.). In particular cases, process P21 is initiated in response to the periodic aggregation process outlined in FIG. 7 (e.g., on a daily basis, during a period when computing resources such as processing are in lower demand). In any case, in determining whether a next interval will be active or inactive, the system 14 checks in decision D22 whether the status (e.g., active or inactive) of a data object 38 has changed in the period (e.g., in the last period that was aggregated, such as the prior day). If the status has not changed, (No to D22), the process repeats decision D22 for a next (remaining) data object 38 to check for status changes. If a status change is detected (Yes to D22), the system 14 checks in decision D23 whether the status change is part of a cyclic pattern. As noted herein, the pattern recognition module 32 can evaluate status changes of data objects 38 to detect patterns, and in certain cases, detects cyclic patterns. If a cyclic pattern is identified (Yes to D23), in process P24, the system 14 recognizes the next interval as cyclic. If the pattern is not cyclic (No to D23), in process P25, the system 14 identifies the pattern as non-cyclic and determines the next interval using time series data. Following either P24 or P25, the system 14 calculates the variance of the time series data in process P26, and checks whether the time series data is active in decision D27. If the time series data is inactive (No to D27), the system 14 determines the next interval, subtracting the calculated variance (process P28). If the time series data is active (Yes to D27), the system 14 determines the next interval, adding the calculated variance (P29). The determination of the next interval is then finalized in process P30.

Returning to FIG. 2, the movement decision engine 34 is configured to apply one or more access activity rules to the identified patterns, in order to determine whether to move one or more data objects 38 from a current storage tier 36 (e.g., between Tier 1 and Tier 3, or Tier 3 and Tier 1, etc.). In some example approaches, time series data (described with reference to FIGS. 6 and 8-10) is divided into two separate time series: i) active interval time series; and ii) inactive time series. Active intervals are forecasted using active time series data over time, while inactive intervals are forecasted separately by inactive time series data over time. When consecutive intervals distribute in a cyclic pattern over time (or an approximately cyclic pattern over time), a rule can be applied to identify the cycle, e.g., a Fast Fourier Transformation and/or Auto Regressive Integrated Moving Average (ARIMA) can be used to identify the cycle. In one example, the cycle of active interval time series [2, 3, 2, 2, 2, 3, 2] is determined as 2. It is understood that in addition to identifying cyclic and other patterns in access activity, the pattern recognition module 32 can be configured to detect approximates of those patterns, e.g., variations on a given pattern. In certain of these cases, the rules include a pattern variation threshold that identifies a particular pattern (e.g., cyclic pattern) when the access activity varies by an amount from the defined pattern. For example, an 80 percent threshold in the rules can identify access activity as exhibiting a cyclic pattern if 80 percent or more of the access activity follows a cyclic pattern. This variation threshold can be set as a percentage amount or a value, e.g., a number of access activity instances within a period.

In particular cases, when the consecutive interval for an object 38 distributes in a stochastic manner, the movement decision engine 34 assumes that the next interval depends on the last N data samples, and forecasts that next interval based on the time series data. In certain examples, the movement decision engine 34 assumes that all samples for an object 38 in a time series have equal weight in order to calculate the next interval, e.g., using average value or median value. In certain other examples, the movement decision engine 34 assumes that different samples for an object 38 in a time series have different weights. In these cases, a more recent sample is assigned a greater weight than an older sample, e.g., using an exponential moving average. In these differential weighting scenarios, the weight for individual older datum points decreases exponentially.

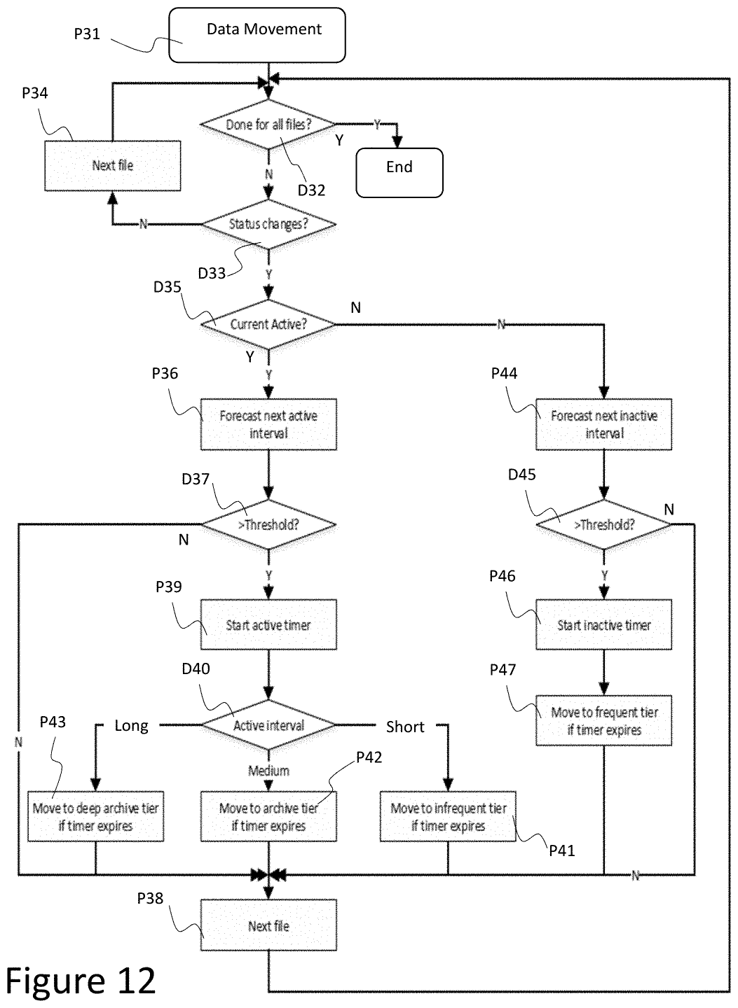

In a particular implementation illustrated in the flow diagram of FIG. 12, system 14 (e.g., including movement decision engine 34) is configured to initiate a movement decision process P31, for example, contemporaneously with, or following the aggregation processes illustrated in FIG. 7 and/or the interval forecasting processes illustrated in FIG. 11. As noted herein, decisions to move data objects 38 can be contemporaneous with determining a future demand status (e.g., active v. inactive), or can be made at any later time that is prior to the predicted future access time for the object 38.

In particular cases, the movement decision process in P31 relates to moving data objects 38 from the first, most-frequent access tier (Tier 1) to a less-frequent access tier (e.g., Tiers 2, 3, or 4, FIG. 2). Turning to FIG. 12, in certain implementations, the system 14 checks (in decision D32) to determine whether data objects 38 have been moved that are determined to have a current demand status that differs from a future demand status. If so (Yes to D32), the process ends. If not (No to D32), in decision D33, the system 14 checks for a status change from the prior period (e.g., from active to inactive, or inactive to active). If not (No to D33), a next object is selected in process P34, and the process is repeated for individual data objects 38 being considered (e.g., a set of data objects 38 in the storage system 10, or all data objects 38 in storage system 10). If the status has changed (Yes to D33), in decision D35 the system 14 checks to determine whether the current status of the data object 38 is active. If the current status of the data object 38 is active (Yes to D35), the system 14 determines the next (future) active interval in process P36, e.g., as described with reference to the interval forecasting approach illustrated FIG. 11. Next, the system 14 determines whether the future active interval satisfies a threshold (decision D37). If not (No to D37), the system 14 proceeds to the next data object 38 (in process P38), and reverts back to D32. If the future active interval satisfies the threshold (Yes to D37), the system 14 starts an active timer in process P39, and in decision D40, sorts the data object 38 (if the timer expires) based on the determined future active interval (e.g., short interval, medium interval, long interval). It is understood that additional intervals and/or distinct terminology can be used to refer to the relative size of the intervals. In the example of three-tier storage system 10 (e.g., FIG. 2) the data objects 38 can be sorted based on intervals of at least two distinct lengths, e.g., a short and medium length, or a medium and large length. FIG. 12 depicts an example with at least four total tiers (Tiers 1, 2, 3, 4) and three corresponding intervals for determining where to move data objects 38, e.g., from a first tier (Tier 1). For example, in the case where Tier 1 is a frequent access tier, a shorter interval can be associated with a less-frequent (or, infrequent) access tier (Tier 2), a medium interval can be associated with an archive tier (Tier 3) with less frequent access than the infrequent tier, and a large interval can be associated with a deep archive tier (Tier 4). In process P41, if the active timer expires, the object 38 with the short active interval is moved from the frequent tier (Tier 1) to the infrequent tier (Tier 2). In process P42, if the active timer expires, the object 38 with the medium active interval is moved from the frequent tier (Tier 1) to the archive tier (Tier 3). In process P43, if the active timer expires, the object 38 with the long active interval is moved from the frequent tier (Tier 1) to the deep archive tier (Tier 4).

Returning to decision D35, if the current status is not active (No to D35), system 14 determines the next inactive interval in process P44 (as described with reference to the interval forecasting approach illustrated FIG. 11). In decision D45, system 14 checks to see if the determined next inactive interval satisfies a threshold, and if not (No to decision D45), proceeds to the next data object 38 (in process P38), and reverts back to D32. If the determined next inactive interval satisfies the threshold (Yes to decision D45), the system 14 starts the inactive interval timer in process P46, and in process P47, moves the data object 38 to Tier 1 (or, frequent tier, in FIG. 2) if the timer expires. In certain cases, the inactive interval timer is based on the difference in time between the forecasted next inactive interval and the current time, e.g., accounting for a variance (as described herein). Following any of processes P41, P42, P43, or P47 the system 14 proceeds to the next data object 38 (in process P38), and reverts back to D32.

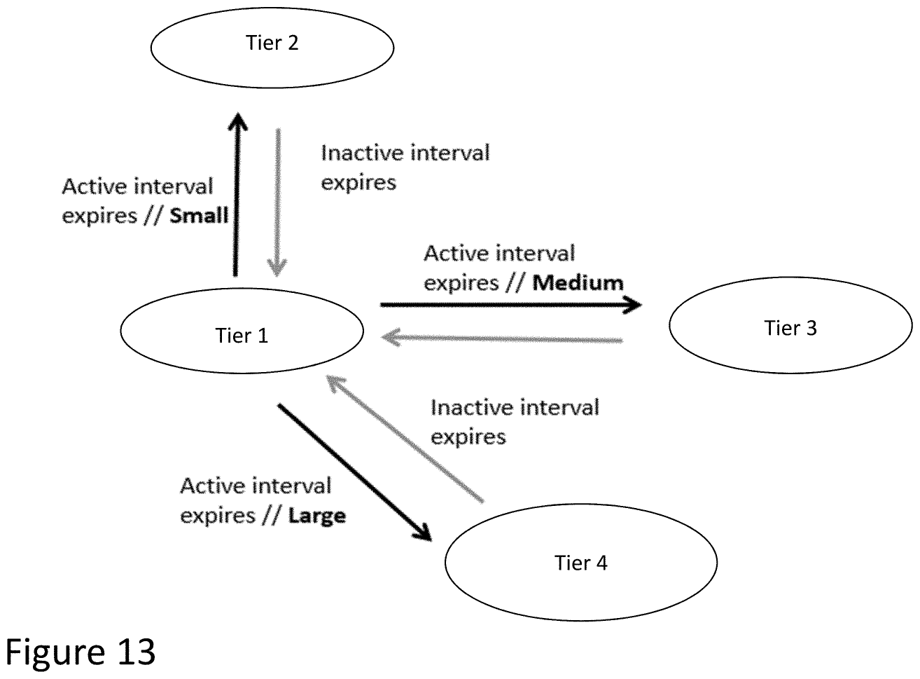

FIG. 13 is a schematic depiction of movement between data tiers according to processes illustrated in FIG. 12, e.g., where a given data object 38 is moved into or out of Tier 1. In certain cases, data object(s) 38 are moved directly from Tier 1 to Tier 3 without any intervening time stored in Tier 2, or from Tier 1 to Tier 4 without any intervening time stored in Tier 2 and/or Tier 3. As illustrated in FIG. 13 in conjunction with FIG. 12, when the access status changes from inactive to active and the next interval satisfies the threshold, the active interval time is started with the determined number of active consecutive days. As described herein, the threshold is tunable to avoid unnecessary or too-frequent back-and-forth movement of data between tiers. In one example scenario, if the determined future active interval is greater than 30 days, a given data object 38 is moved from Tier 1 to Tier 2. In another example, if that determined future active interval is greater than 60 days, a given data object 38 is moved from Tier 1 to Tier 3. In another example, if that determined future active interval is greater than 180 days, a given data object 38 is moved from Tier 1 to Tier 4.

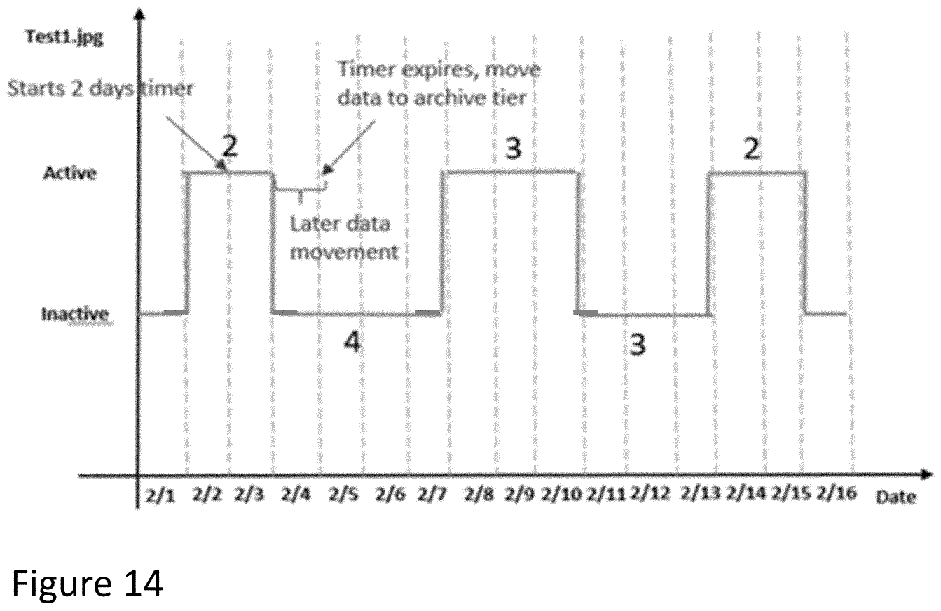

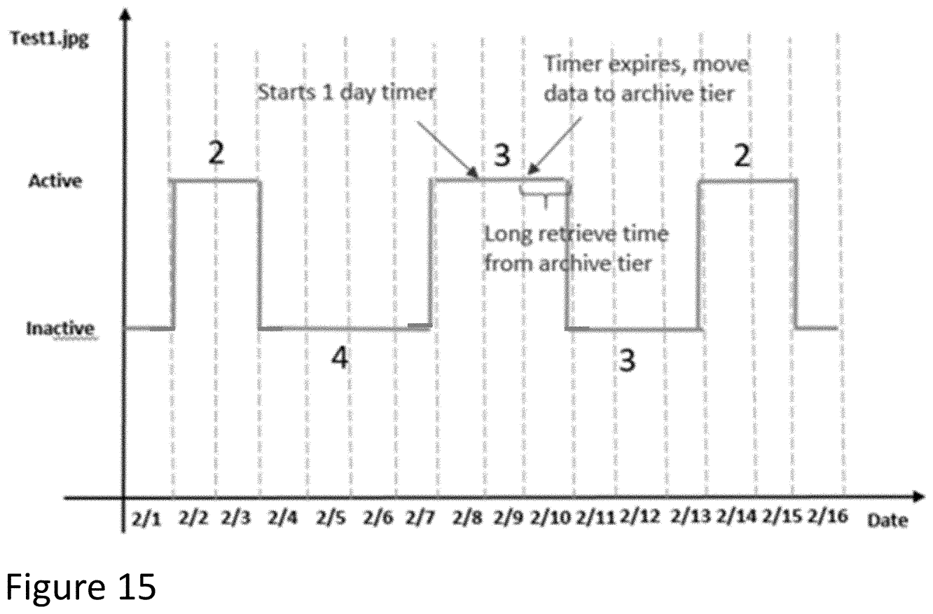

In certain implementations, the system 14 is configured to use a statistical variance in determining when to move a data object 38 between tiers, e.g., from Tier 1 to any of the less-frequent access tiers. The use of a statistical variance can avoid undesirable scenarios where an object 38 is either moved from Tier 1 too soon (increasing delay in retrieval from Tier 2, Tier 3, etc.), or where an object 38 is moved too late (adding unnecessary resource usage). For example, FIG. 14 is a graphical depiction of the time series of access activity for an example data object 38, annotated to illustrate too-late movement of a data object 38. That is, when the determined future active interval is larger than the actual value, the data object 38 is not moved until after the actual status transition period (e.g., day). This lag in movement of data objects 38 depends on the gap between the determined (future) value and the actual value. FIG. 15 is a graphical depiction of the time series of access activity for the data object 38, annotated to illustrate too-soon movement of the data object 38. In this case, where the determined future active interval is less than the actual value, the system 14 moves data objects 38 prior to the actual status transition period (e.g., day). This results in a greater latency than is necessary to retrieve the data object. Despite these shortcomings in particular examples, the system 14 functioning without a variance adjustment still demonstrates greater efficiency of resource usage and expenditure than conventional systems.

However, in certain cases, the system 14 is configured to further enhance movement of data objects 38 in the storage system by accounting for a statistical variance when making the decision on when to move those objects 38. In particular implementations, the system 14 can also account for a statistical variance (e.g., +1 or +2 variances, or −1 or −2 variances) to enhance the chances of moving a greater number of data objects 38 to lower-priority tiers (e.g., Tiers 2, 3, 4, etc.). For example, a variance can be added to the forecast interval for active time series data, while a variance can be subtracted from the forecast interval for inactive time series data, to enhance the chances of accurately moving data objects 38 between tiers. That is, in certain cases, the final determined future value of the active interval is equal to the original determined (forecast) value plus a statistical variance of +1 or +2. Additionally, in certain cases, the final determined future value of the inactive interval is equal to the original determined (forecast) value minus a statistical variance of −1 or −2. In certain implementations, the variance is calculated using the time series data for a given data object 38 (e.g., FIG. 14, FIG. 15). In particular examples, use of a variance in determining whether to move data objects 38 to lower-priority tiers (e.g., Tiers 2, 3, 4, etc.) can prevent premature movement of those data objects 38, thereby decreasing latency in accessing those data objects 38 during the period accounted for in the variance.

In certain embodiments, the system 14, including rules applied by modules and/or engines therein (e.g., pattern recognition module 32 and/or movement decision engine 34) can be trained over time to more effectively recognize patterns in activity data and/or statistical variances in movement decisions. In particular embodiments, the system 14 can include one or more machine learning (ML) engines configured to be trained on data (e.g., actual usage data) to refine the rules for recognizing patterns in activity for data objects 38 and movement of data objects 38 between tiers. In various embodiments, the system 14 can be trained with data specific to a particular user and/or group of users, e.g., to tailor the movement decision rules for the user(s). Additionally, user(s) can define and/or modify one or more rules, e.g., via an interface command on any device connected with the storage management service 12 (FIG. 2).

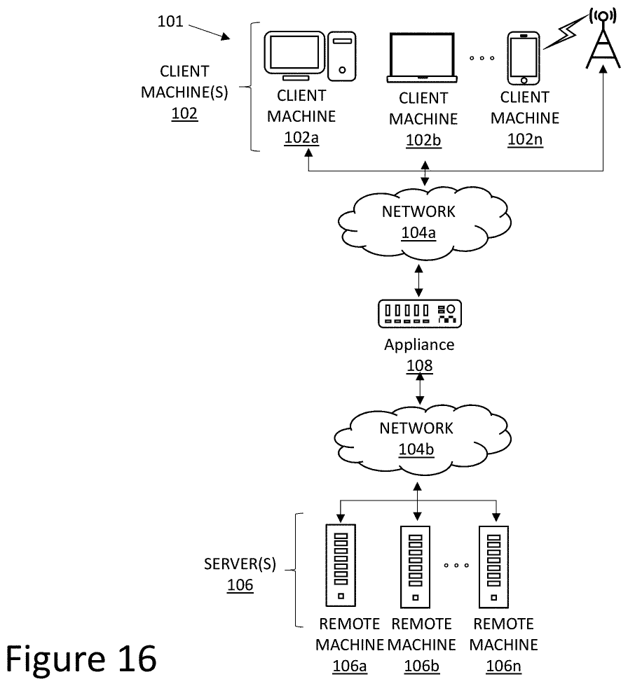

Referring to FIG. 16, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

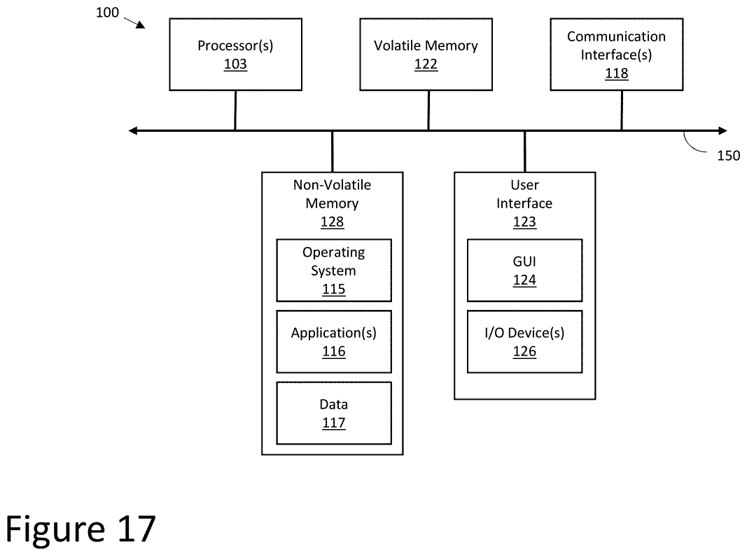

FIG. 17 depicts a block diagram of a computing device 100 useful for practicing an embodiment of client devices 102, appliances 108 and/or servers 106. The computing device 100 includes one or more processors 103, volatile memory 122 (e.g., random access memory (RAM)), non-volatile memory 128, user interface (UI) 123, one or more communications interfaces 118, and a communications bus 150.

The non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

The non-volatile memory 128 stores an operating system 115, one or more applications 116, and data 117 such that, for example, computer instructions of the operating system 115 and/or the applications 116 are executed by processor(s) 103 out of the volatile memory 122. In some embodiments, the volatile memory 122 may include one or more types of RAM and/or a cache memory that may offer a faster response time than a main memory. Data may be entered using an input device of the GUI 124 or received from the I/O device(s) 126. Various elements of the computer 100 may communicate via the communications bus 150.

The illustrated computing device 100 is shown merely as an example client device or server, and may be implemented by any computing or processing environment with any type of machine or set of machines that may have suitable hardware and/or software capable of operating as described herein.

The processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 103 may be analog, digital or mixed-signal. In some embodiments, the processor 103 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 118 may include one or more interfaces to enable the computing device 100 to access a computer network such as a Local Area Network (LAN), a Wide Area Network (WAN), a Personal Area Network (PAN), or the Internet through a variety of wired and/or wireless connections, including cellular connections.

In described embodiments, the computing device 100 may execute an application on behalf of a user of a client device. For example, the computing device 100 may execute one or more virtual machines managed by a hypervisor. Each virtual machine may provide an execution session within which applications execute on behalf of a user or a client device, such as a hosted desktop session. The computing device 100 may also execute a terminal services session to provide a hosted desktop environment. The computing device 100 may provide access to a remote computing environment including one or more applications, one or more desktop applications, and one or more desktop sessions in which one or more applications may execute.

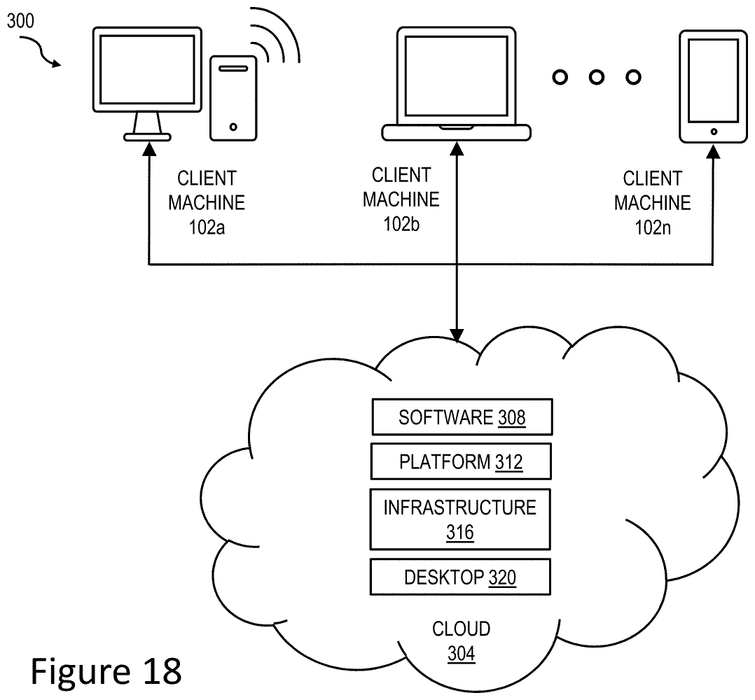

Referring to FIG. 18, a cloud computing environment 300 is depicted, which may also be referred to as a cloud environment, cloud computing or cloud network. The cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 300, one or more clients 102a-102n (such as those described above) are in communication with a cloud network 304. The cloud network 304 may include back-end platforms, e.g., servers, storage, server farms or data centers. The users or clients 102a-102n can correspond to a single organization/tenant or multiple organizations/tenants. More particularly, in one example implementation the cloud computing environment 300 may provide a private cloud serving a single organization (e.g., enterprise cloud). In another example, the cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 300 may provide a hybrid cloud that is a combination of a public cloud and a private cloud. Public clouds may include public servers that are maintained by third parties to the clients 102a-102n or the enterprise/tenant. The servers may be located off-site in remote geographical locations or otherwise.

The cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 300 can provide an elasticity to dynamically scale out or scale in response to different demands from one or more clients 102. In some embodiments, the cloud computing environment 300 can include or provide monitoring services to monitor, control and/or generate reports corresponding to the provided shared services and resources.

In some embodiments, the cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

The following paragraphs (S1) through (S10) describe examples of systems and devices that may be implemented in accordance with the present disclosure.

(S1) A computing device may comprise: a memory; and a processor coupled to the memory and configured to store data objects in a storage system, the storage system being a multi-tier storage system, and the storage of data objects including: determining a future demand status for at least one data object stored in the storage system based on a set of access activity rules; and moving the at least one data object between tiers of the storage system in response to the determined future demand status being different from a current demand status of the at least one data object to reduce consumption of resources in which to store that data object.

(S2) A computing device may be configured as described in paragraph (S1), wherein the processor is further configured to: record access metrics for the data objects over a period; and update at least one activity record in the access metrics for a data object within the period.

(S3) A computing device may be configured as described in paragraphs (S1) and (S2), wherein one of the access metrics includes a per-period access count, and wherein: a) the data objects are assigned a current demand status of active if access is detected within the period, or b) the data objects are assigned a current demand status of inactive if access is not detected within the period.

(S4) A computing device may be configured as described in paragraphs (S1) and (S2), wherein the processor is further configured to update the at least one activity record on a daily basis, wherein the at least one activity record includes an access counter including a log of a number of access instances for the data object within a day.

(S5) A computing device may be configured as described in paragraphs (S1), (S2) and (S4), wherein determining the future demand status comprises: identifying a pattern in the log of the number of instances of access for the data object over an extended period greater than the period; and assigning an active interval or an inactive interval to the data object, the assignment being representative of a predicted future time of access for the data object based on the access pattern.

(S6) A computing device may be configured as described in paragraph (S1), wherein the storage system includes at least three distinct storage tiers.

(S7) A computing device may be configured as described in paragraphs (S1) and (S6), wherein the storage system includes: a first tier in which to access one or more data objects on a frequent basis, a second tier in which to access one or more data objects on basis less frequent than the first tier, and a third tier in which to archive data objects accessible on a basis less than the first and second tiers.

(S8) A computing device may be configured as described in paragraphs (S1) and (S7), wherein the first tier has a first access latency, the second tier has a second access latency, and the third access tier has a third access latency, wherein the first access latency is less than the second access latency, and the second access latency is less than the third access latency.

(S9) A computing device may be configured as described in paragraphs (S1) and (S7), wherein the at least one data object is moved directly from the first tier to the third tier based on the determined future demand status.

(S10) A computing device may be configured as described in paragraph (S1), wherein moving the at least one data object is performed either contemporaneously with determining the future demand status or at a later time that is prior to a predicted future access time for the at least one data object.

The following paragraphs (M1) through (M8) describe examples of methods that may be implemented in accordance with the present disclosure.

(M1) A method may involve storing data objects in a storage system, the method comprising: determining a future demand status for at least one data object stored in the storage system based on a set of access activity rules; and moving the at least one data object between tiers of the storage system in response to the determined future demand status being different from a current demand status of the at least one data object to reduce consumption of resources in which to store that data object.

(M2) A method may be provided as described in paragraph (M1), further comprising: recording access metrics for the data objects over a period; and updating at least one activity record in the access metrics for a data object within the period.

(M3) A method may be provided as described in paragraphs (M1) and (M2), wherein one of the access metrics includes a per-period access count, and wherein the data objects are assigned a current demand status of active if access activity is detected within the period and are assigned a current demand status of inactive if access activity is not detected within the period.

(M4) A method may be provided as described in paragraphs (M1) and (M2), wherein the at least one activity record is updated on a daily basis, wherein the at least one activity record includes an access counter including a log of a number of access instances for the data object within a day.

(M5) A method may be provided as described in paragraphs (M1) and (M4), wherein determining the future demand status comprises: identifying a pattern in the log of the number of instances of access for the data object over an extended period greater than the period; and assigning an active interval or an inactive interval to the data object, the assignment being representative of a predicted future time of access for the data object based on the access pattern.

(M6) A method may be provided as described in paragraph (M1), wherein the storage system includes: a first tier in which to access one or more data objects on a frequent basis, a second tier in which to access one or more data objects on a basis less frequent than the first tier, and a third tier in which to archive data objects accessible on a basis less than the first and second tiers.

(M7) A method may be provided as described in paragraph (M6), wherein the at least one data object is moved directly from the first tier to the third tier based on the determined future demand status.

(M8) A method may be provided as described in paragraph (M1), wherein moving the at least one data object is performed either contemporaneously with determining the future demand status or at a later time that is prior to a determined future access time for the at least one data object.

The following paragraphs (CRM1) through (CRM2) describe examples of computer readable media that may be implemented in accordance with the present disclosure.

(CRM1) A computer readable medium may have program code, which when executed by a computing device, causes the computing device to store data objects in a storage system by perform actions comprising: determining a future demand status for at least one data object stored in the storage system based on a set of access activity rules; and moving the at least one data object between tiers of the storage system in response to the determined future demand status deviating from a current demand status of the at least one data object to reduce consumption of resources in which to store that data object.

(CRM2) A computer readable medium as described in (CRM1), wherein the multi-tier cloud storage system includes: a first tier in which to access one or more data objects on a frequent basis, a second tier in which to access one or more data objects on a basis less frequent than the first tier, a third tier in which to archive data objects accessible on a basis less than the first and second tiers, wherein the first tier has a first access latency, the second tier has a second access latency, and the third tier has a third access latency, wherein the first access latency is less than the second access latency, and the second access latency is less than the third access latency, and wherein moving the at least one data object is performed either contemporaneously with determining the future demand status or at a later time that is prior to a determined future access time for the at least one data object.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

We claim:

1. A computing device, comprising:
a memory; and
a processor coupled to the memory and configured to store data objects in a storage system, the storage system being a multi-tier storage system, and the storage of data objects including:
determining a future demand status for at least one data object stored in the storage system based on a set of access activity rules; and
moving the at least one data object between tiers of the storage system in response to the determined future demand status being different from a current demand status of the at least one data object to reduce consumption of resources in which to store that data object.

2. The computing device of claim 1, wherein the processor is further configured to:
record access metrics for the data objects over a period; and
update at least one activity record in the access metrics for a data object within the period.

3. The computing device of claim 2, wherein one of the access metrics includes a per-period access count, and wherein:
a) the data objects are assigned a current demand status of active if access is detected within the period, or
b) the data objects are assigned a current demand status of inactive if access is not detected within the period.

4. The computing device of claim 2, wherein the processor is further configured to update the at least one activity record on a daily basis, wherein the at least one activity record includes an access counter including a log of a number of access instances for the data object within a day.

5. The computing device of claim 4, wherein determining the future demand status comprises:
identifying a pattern in the log of the number of instances of access for the data object over an extended period greater than the period; and
assigning an active interval or an inactive interval to the data object, the assignment being representative of a predicted future time of access for the data object based on the access pattern.

6. The computing device of claim 1, wherein the storage system includes at least three distinct storage tiers.

7. The computing device of claim 6, wherein the storage system includes: a first tier in which to access one or more data objects on a frequent basis, a second tier in which to access one or more data objects on basis less frequent than the first tier, and a third tier in which to archive data objects accessible on a basis less than the first and second tiers.

8. The computing device of claim 7, wherein the first tier has a first access latency, the second tier has a second access latency, and the third access tier has a third access latency, wherein the first access latency is less than the second access latency, and the second access latency is less than the third access latency.

9. The computing device of claim 7, wherein the at least one data object is moved directly from the first tier to the third tier based on the determined future demand status.

10. The computing device of claim 1, wherein moving the at least one data object is performed either contemporaneously with determining the future demand status or at a later time that is prior to a predicted future access time for the at least one data object.

11. A method of storing data objects in a storage system, the method comprising:
determining a future demand status for at least one data object stored in the storage system based on a set of access activity rules; and
moving the at least one data object between tiers of the storage system in response to the determined future demand status being different from a current demand status of the at least one data object to reduce consumption of resources in which to store that data object.

12. The method of claim 11, further comprising:
recording access metrics for the data objects over a period; and
updating at least one activity record in the access metrics for a data object within the period.

13. The method of claim 12, wherein one of the access metrics includes a per-period access count, and wherein the data objects are assigned a current demand status of active if access activity is detected within the period and are assigned a current demand status of inactive if access activity is not detected within the period.

14. The method of claim 12, wherein the at least one activity record is updated on a daily basis, wherein the at least one activity record includes an access counter including a log of a number of access instances for the data object within a day.

15. The method of claim 14, wherein determining the future demand status comprises:
identifying a pattern in the log of the number of instances of access for the data object over an extended period greater than the period; and
assigning an active interval or an inactive interval to the data object, the assignment being representative of a predicted future time of access for the data object based on the access pattern.

16. The method of claim 11, wherein the storage system includes:
a first tier in which to access one or more data objects on a frequent basis,
a second tier in which to access one or more data objects on a basis less frequent than the first tier, and
a third tier in which to archive data objects accessible on a basis less than the first and second tiers.

17. The method of claim 16, wherein the at least one data object is moved directly from the first tier to the third tier based on the determined future demand status.

18. The method of claim 11, wherein moving the at least one data object is performed either contemporaneously with determining the future demand status or at a later time that is prior to a determined future access time for the at least one data object.

19. A computer readable medium having program code, which when executed by a computing device, causes the computing device to store data objects in a storage system by perform actions comprising:
determining a future demand status for at least one data object stored in the storage system based on a set of access activity rules; and
moving the at least one data object between tiers of the storage system in response to the determined future demand status deviating from a current demand status of the at least one data object to reduce consumption of resources in which to store that data object.

20. The computer readable medium of claim 19, wherein the multi-tier cloud storage system includes:
a first tier in which to access one or more data objects on a frequent basis,
a second tier in which to access one or more data objects on a basis less frequent than the first tier,
a third tier in which to archive data objects accessible on a basis less than the first and second tiers,
wherein the first tier has a first access latency, the second tier has a second access latency, and the third tier has a third access latency, wherein the first access latency is less than the second access latency, and the second access latency is less than the third access latency, and
wherein moving the at least one data object is performed either contemporaneously with determining the future demand status or at a later time that is prior to a determined future access time for the at least one data object.
